(19) United States
(12) Patent Application Publication
(10) Pub. No.: US 2007/0097311 A1
(43) Pub. Date: May 3, 2007

(54) LIQUID CRYSTAL DISPLAY PANEL AND MANUFACTURING METHOD OF COLOR FILTERING DEVICE AND LIQUID CRYSTAL DISPLAY PANEL

(76) Inventors: De-Jiun Li, Taipei County (TW); Der-Chun Wu, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/163,898

(22) Filed: Nov. 3, 2005

(30) Foreign Application Priority Data
Oct. 27, 2005 (YE) 94137594

(51) Int. Cl. G02F 1/1339

(52) U.S. Cl. 349/155

(57) ABSTRACT

The manufacturing method of color filtering device in the present invention provides a substrate with a patterned light-shielding layer formed therein. Next, a color filtering unit is formed in each of the sub-pixel regions defined by the patterned light-shielding layer and each of the color filtering units is partially overlapped on the patterned light-shielding layer. In particular, at least parts of the color filtering units have at least one opening respectively and the openings are disposed above the patterned light-shielding layer. Afterwards, an electrode layer is formed conformally on the substrate. Then, a plurality of spacers are formed on the electrode layer and inserted into the color filtering units through the corresponding openings respectively.

### BACKGROUND OF THE INVENTION

1. Field of Invention

The present invention relates to a manufacturing method of display panel, and particularly to a liquid crystal display panel and a manufacturing method of a color filtering device and the liquid crystal display panel.

2. Description of the Related Art

The rapid advancement in multimedia community benefits from the leaping progress in semiconductor component and display device. For display device, the liquid crystal display (LCD) with superior characteristics, such as high display quality, better efficiency for space usage, low power consumption, and no radiation, has become the main stream in the market.

Since each of the properties of the liquid crystal display, such as response speed, contrast, and viewable angle, is related to cell gap, the cell gap is strictly controlled according to the optical characteristics of the liquid crystal material. Besides, once the liquid crystal display has different cell gaps, the display quality would be decreased, and the visibility of images would be diminished. Therefore, spacers are used to dispose between two substrates of the liquid crystal display panel, so as to maintain the cell gap in a constant. In general, pillared spacers can provide the display panel with more homogeneous cell gap, better transmittance, and higher contrast so that the conventional round spacers are usually replaced by the pillared ones.

The present spacers are mostly formed on the color filter such that this kind of spacer is called ‘SOC’ (spacer on color filter). FIG. 1A is a partial top view illustrating conventional color filter with spacers and FIG. 1B is a cross-sectional diagram along direction A-A′ in FIG. 1A. Referring to FIG. 1A and FIG. 1B, the color filter 100 includes a substrate 102, a black matrix 110, a color filtering unit 120, and a second electrode layer 130. Wherein, the color filtering unit 120 is disposed within a sub-pixel region 104 on the substrate 102 enclosed by the black matrix 110 and partially overlapped with the black matrix 110. The second electrode layer 130 is conformally disposed on the substrate 102 and a spacer 140 is disposed on the second electrode layer 130 above the overlap of the color filtering unit 120 and the black matrix 110.

However, because there is no adhesion layer between the spacer 140 and the color filter 100, in the following processes of forming alignment film (not shown) such as washing, Pi transform, alignment, and even rewashing after removing films, it is easy to cause the spacer 140 to peel off the color filter 100 because of the added lateral shear stress. Therefore, the cell gap of the liquid crystal display panel is not homogeneous so that abnormal image display, so-called mura phenomena, is performed.

### SUMMARY OF THE INVENTION

Accordingly, an object of the present invention is to provide a manufacturing method of liquid crystal display panel, wherein a liquid crystal display panel with homogeneous cell gap is made to increase the productive yields of manufacturing process.

Another object of the present invention is to provide a manufacturing method of a color filtering device for increasing the ability of taking lateral shear stress on the color filtering device.

Another object of the present invention is to provide a liquid crystal display with homogeneous cell gap, so as to provide good display quality.

Based on the foregoing or other purposes, the present invention provides a manufacturing method of liquid crystal display panel. First, a first substrate and a second substrate are provided, wherein a first electrode layer is already formed on the first substrate. A patterned light-shielding layer is formed on the second substrate to define a plurality of sub-pixel regions on the second substrate. Afterward, a color filtering unit is formed within each of the sub-pixel regions, and the color filtering units are partially overlapped with the patterned light-shielding layer. Particularly, at least parts of color filtering units have at least one opening respectively, wherein the openings are disposed above the patterned light-shielding layer.

According to the foregoing description, a second electrode layer is formed conformally on the second substrate, and then a plurality of spacers is formed on the second electrode layer. Each of the spacers is inserted into one of the color filter units through the corresponding opening. Next, the first substrate and the second substrate are composed and a liquid crystal layer is formed in between. Moreover, the first substrate and the second substrate are disposed correspondingly, the cell gap between the first substrate and the second substrate is held by the spacers.

According to an embodiment of the present invention, the method for forming the spacers is, for example, to form a photoresist material layer on the second electrode layer first, wherein the photoresist material layer fills the openings. Then, the photoresist material layer outside the surroundings of each of the openings is removed to form the spacers.

According to an embodiment of the present invention, the above-mentioned color filtering units include, for example, red color filtering units, green color filtering units, and blue color filtering units.

According to an embodiment of the present invention, the first substrate is an active device array substrate and the second substrate is a color filter.

According to an embodiment of the present invention, the second substrate further includes an active device array which is preformed, and the patterned light-shielding layer is formed on the active device array.

The present invention also provides a manufacturing method of color filtering device. First, a substrate is provided with a patterned light-shielding layer formed therein to define a plurality of sub-pixel regions on the substrate. Next, a color filtering unit is formed within each of the sub-pixel regions on the substrate, wherein each of the color filtering units is partially overlapped with the patterned light-shielding layer. Particularly, at least parts of the color filtering units have at least one opening respectively, and the openings are disposed above the patterned light-shielding layer. Afterward, an electrode is formed conformally on the substrate. Then, a plurality of spacers are formed on the electrode layer and inserted into the color filtering units through the corresponding openings respectively.

According to an embodiment of the present invention, the foregoing step for forming openings in the color filtering units is, for example, to title the side walls of the openings corresponding to the bottom surface.

According to an embodiment of the present invention, the method for forming the above-mentioned spacers is, for example, to form a photoresist material layer on the electrode layer, wherein the foregoing openings is filled with the photoresist material layer. Next, the photoresist material layer outside the surroundings of each opening is removed to form the spacers.

According to an embodiment of the present invention, the substrate further includes an active device array which is preformed, and the patterned light-shielding layer is formed on the active device array.

The present invention also provides a liquid crystal display panel, including a first substrate, a second substrate, a patterned light-shielding layer, a plurality of color filtering units, a conformal electrode layer, a plurality of spacers and a liquid layer. Wherein, the electrode layer is disposed on the first substrate, and the second substrate is disposed corresponding to the first substrate. The patterned light-shielding layer is disposed on the surface of the second substrate corresponding to the first substrate to define a plurality of sub-pixel regions on the second substrate. The color filtering units are disposed on the sub-pixel regions, respectively. Wherein, at least portions of the color filtering units have an opening, respectively, and the openings are placed above the patterned light-shielding layer. The electrode layer is disposed on the patterned light-shielding layer and the color filtering units, and the electrode layer fills the openings. The spacers are disposed on the second electrode layer and inserted into the color filtering units through the corresponding openings, respectively. The liquid crystal layer is disposed between the first substrate and the second substrate.

According to an embodiment of the present invention, the liquid crystal display panel further includes an active device array disposed on the first substrate.

According to an embodiment of the present invention, the liquid crystal display panel further includes an active device array which is disposed on the second substrate, wherein the patterned light-shielding layer is disposed on the active device array.

According to an embodiment of the present invention, the spacers are pillared spacers.

Because the spacers in the present invention are inserted in the color filtering units, the lateral shear stress endured by the spacers can be increased to avoid the spacers peeling off the color filter in the following manufacturing process of washing, forming alignment film, or aligning alignment film. It can be known that the liquid crystal display panel manufactured according to the present invention can have homogeneous cell gaps to maintain superior display quality.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1A to FIG. 1B are cross-sectional diagram illustrating a conventional color filter with spacers.

FIG. 2A to FIG. 2D are top views of structures for the manufacturing processes of a color filtering device according to an embodiment of the present invention.

FIG. 3A to FIG. 3D are cross-sectional diagrams along the direction I-I′ of the structures in FIG. 2A to FIG. 2D.

FIG. 4 is a cross-sectional diagram of a color filtering unit having openings to an embodiment of the present invention.

FIG. 5 is a cross-sectional diagram of forming a photoresist material layer on an electrode layer to an embodiment of the present invention.

FIG. 6 is a cross-sectional diagram of color filtering device to a second embodiment of the present invention.

FIG. 7A is a top view of forming a bottom substrate of the liquid crystal display panel to an embodiment of the present invention.

FIG. 7B to FIG. 7C are cross-sectional diagrams for the manufacturing processes of the liquid crystal display panel to an embodiment of the present invention.

FIG. 8 is a cross-sectional diagram of liquid crystal display panel to another embodiment of the present invention.

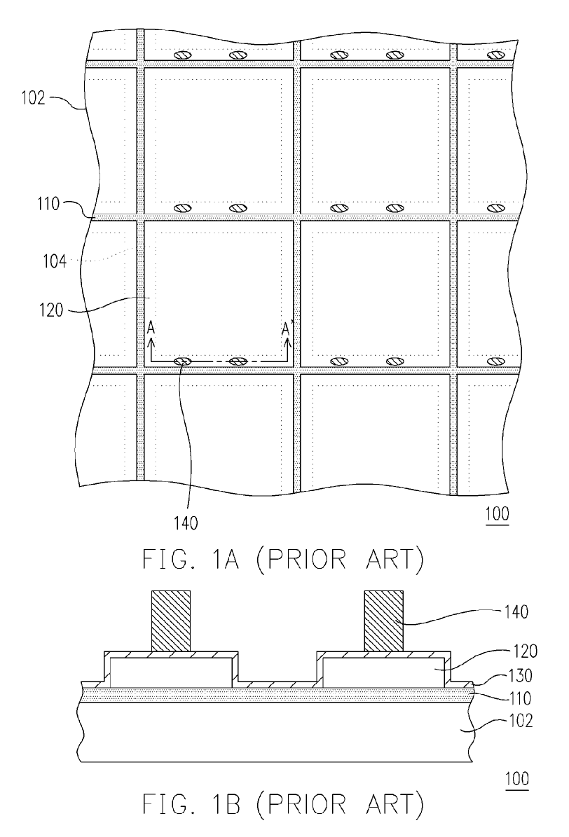

### DESCRIPTION OF THE EMBODIMENTS

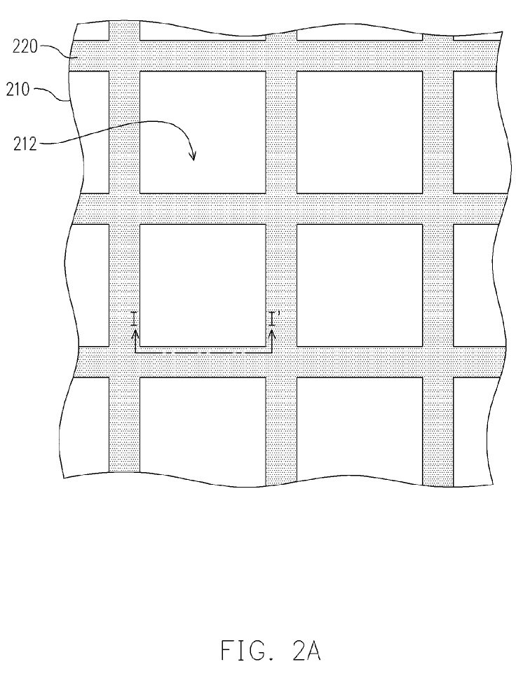

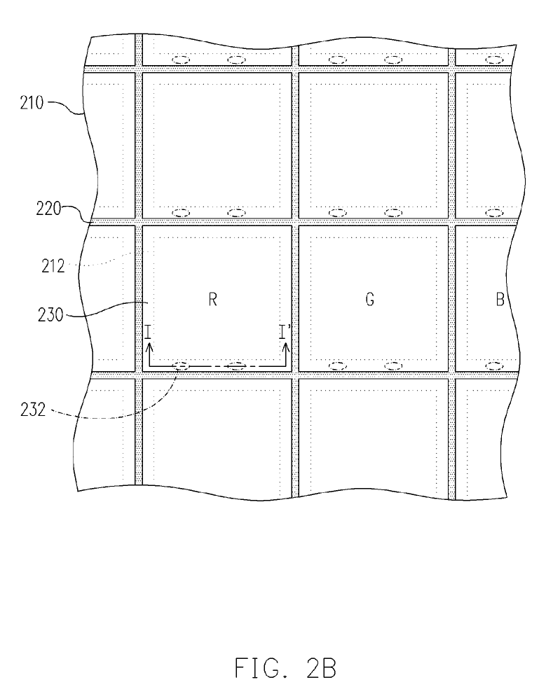

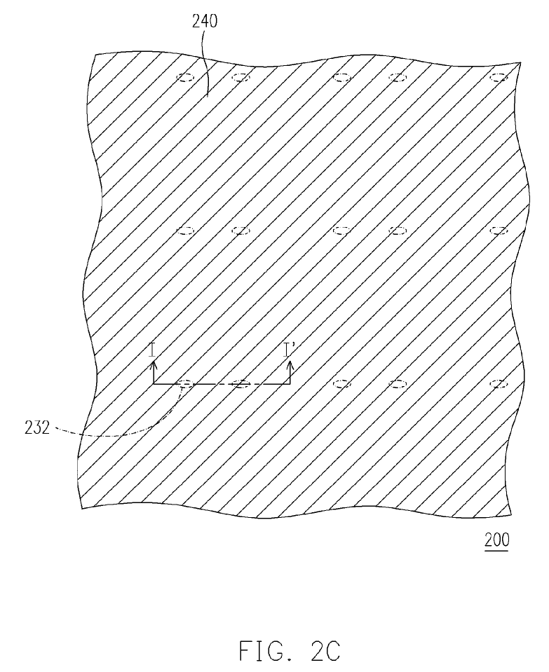

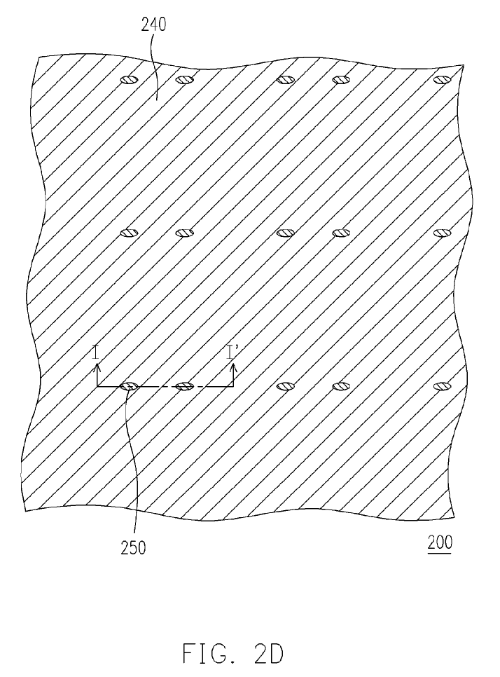

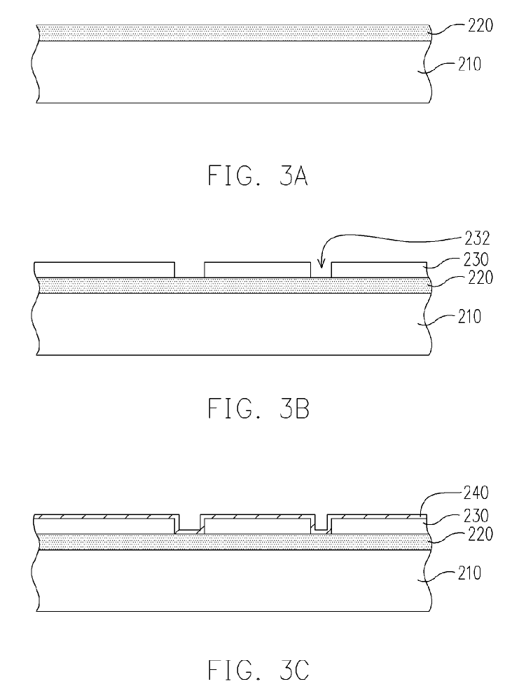

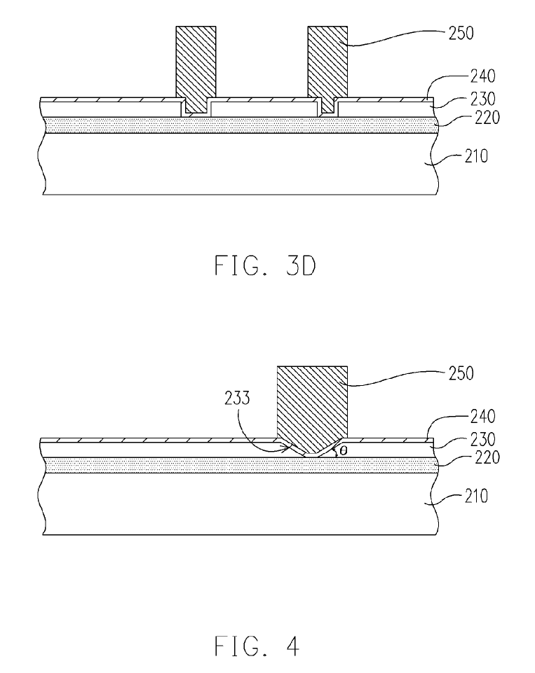

FIG. 2A to FIG. 2D are top views of structures for the manufacturing processes of a color filtering device according to a first embodiment of the present invention. FIG. 3A to FIG. 3D are cross-sectional diagrams along the direction I-I′ of the structures in FIG. 2A to FIG. 2D.

Referring to FIG. 2A and FIG. 3A, first, a substrate 210 is provided and a patterned light-shielding layer 220 is formed on the substrate 210 to define a plurality of sub-pixel regions 212 on the substrate 210. In other words, the patterned light-shielding layer 220 is the so-called black matrix (BM).

Referring to FIG. 2B and FIG. 3B, a plurality of color filtering units 230 are formed on the substrate 210, wherein the color filtering units 230 are disposed within the corresponding sub-pixel regions 212 respectively. For full color technique, the color filtering units 230 can have one of the three primary colors and can be red color filtering units R, green color filtering units G, and blue color filtering units B. In addition, parts of color filtering units 230 are partially overlapped with the patterned light-shielding layer 220 in order to increase the aperture ratio of LCD panel formed by the color filter. In particular, at least parts of the color filtering units 230 have openings 232 at the overlap with the patterned light-shielding layer 220, wherein parts of the patterned light-shielding layer 220 can be exposed or cannot be exposed by the openings 232, which are not limited in the present invention. Besides, the side walls 233 of the openings 232 can be titled corresponding to the bottom surface (as shown in FIG. 4) and the tilt angle can be 30 degrees.

Accordingly, if the color filtering units 230 are formed by the manufacturing process of photolithography and etching, the openings 232 and the color filtering units 230 can be made in the same manufacturing process without increasing the number of mask additionally.

Referring to FIG. 2C and FIG. 3C, an electrode layer 240 is formed conformally on the substrate 210. Afterwards, referring to FIG. 2D and FIG. 3D, a plurality of spacers 250 are formed on the electrode layer 240 and inserted into the color filtering units 230 through the corresponding openings 232 in order to increase the area of attachment between the spacers 250 and the color filter 200, so as to increase the adhesion of the spacers 250. Accordingly, the cross-sectional area where the spacers 250 insert into the color filtering units 230 can be smaller than the cross-sectional area exposed outside the color filtering units 230. In other words, the spacers 250 can be partially disposed on the electrode layer 240 above the color filtering units 230, so as to increase the adhesion of the spacers 250. Moreover, the spacers 250 can be pillared spacers.

Based on the foregoing description, the method of forming the spacers 250 is, for example, to form a photoresist material layer 260 on the electrode layer 240 of the FIG. 3C to fill the openings 232, as shown in FIG. 5. Next, through manufacturing process of photolithography and etching, the photoresist material layer 260 outside the surroundings of the openings 232 is removed. Therefore, the spacers 250 inserted into the color filtering units 230 in FIG. 3D can be formed. The color filtering device 200 with spacers 250 is roughly completed and the color filtering device 200 is the color filter generally used in display panels.

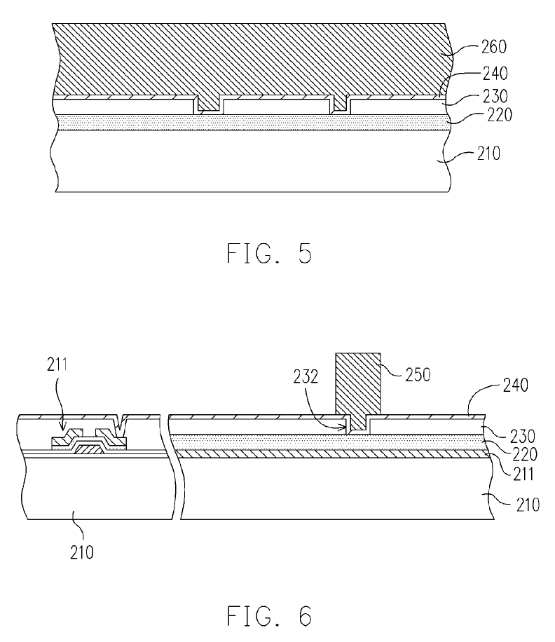

Accordingly, in one embodiment, the foresaid manufacturing processes can also be used for forming color filter on array (COA). FIG. 6 is a cross-sectional diagram of a color filtering device to a second embodiment of the present invention. Referring to FIG. 6, the manufacturing processes of color filtering device provide a substrate 210 and forms an active device array 211 and a patterned light-shielding layer 220 on the substrate 210 sequentially. Afterwards, the method of forming a color filtering unit 230, an electrode layer 240 and spacers 250 are similar to the first embodiment, so the description of those is omitted here. The color filtering device 300 formed in the present embodiment is generally used for the COA substrate of display panel, wherein the electrode layer 240 is the so-called pixel electrode.

It can be known that the present invention is not limited to the disposition of the color filtering units that the spacers insert in. In other words, the spacers of the present invention can be inserted into the color filtering units of general color filter or can be inserted into the color filtering units of COA substrate. Moreover, the spacers of the present invention can also be inserted into the color filtering units disposed inside dummy pixel region, so as to provide the spacers with the effect of buffering the flow rate of liquid crystal and further prevent the liquid crystal molecules from being polluted by unsolidified sealant in the manufacturing processes of composing liquid crystal display panel using the color filtering device.

It can be known for those skilled in the art that if the SOC technique is used for forming the spacers of liquid crystal display panel, a one drop fill (ODF) process is generally used for forming liquid crystal layer in the liquid crystal display panel. The manufacturing processes of the liquid crystal display panel are illustrated as follows.

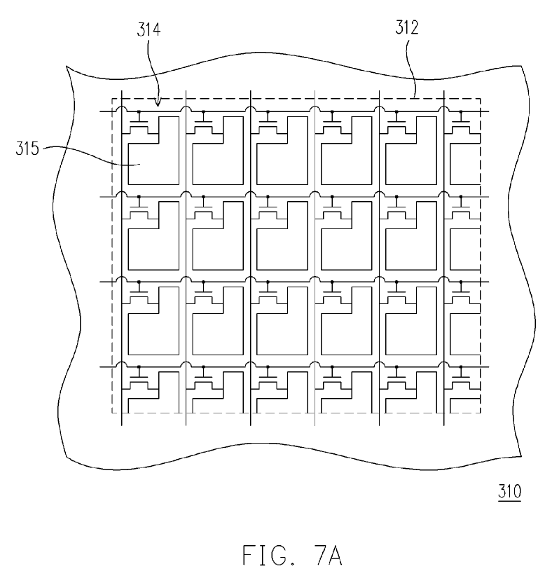

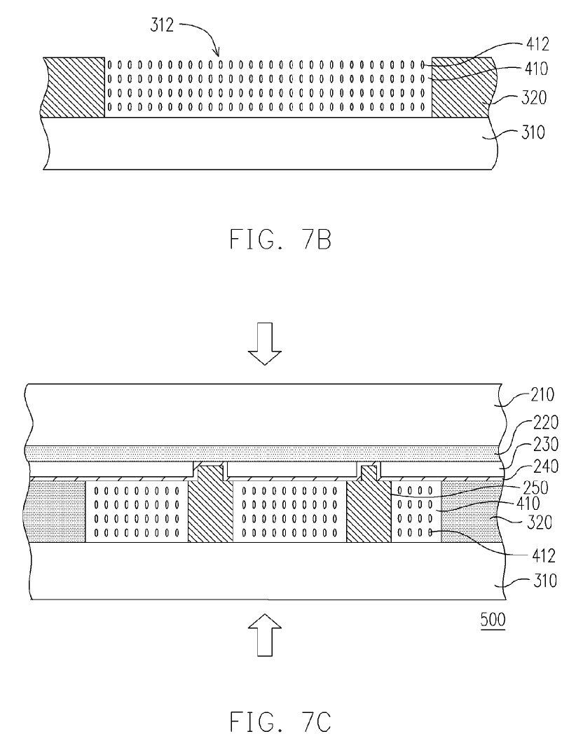

FIG. 7A is a top view of a substrate of the liquid crystal display panel to an embodiment of the present invention. FIG. 7B to FIG. 7C are cross-sectional diagrams for the manufacturing processes of the liquid crystal display panel to an embodiment of the present invention. Referring to FIG. 7A, first, a substrate 310 such as an active device array substrate is provided, wherein the substrate 310 has a display area 312 with an active device array 314 formed therein and the active device array 314 includes an electrode layer 315 which is the so-called pixel electrode. Wherein, the active device array 314 can be a thin film transistor array (TFT array). The detailed manufacturing process is apparent to those skilled in the art, so the description of those is omitted here.

Referring to FIG. 7B, a sealant 320 is then formed on the substrate 310 to enclose the display area 312. Afterwards, a liquid crystal layer 410 is formed by injecting liquid crystal molecules 412 within a display area 312 using the method of one drop fill. Therefore, the liquid crystal layer 400 can be sealed up between the substrate 310 and the color filtering device 200 in the following manufacturing processes. Accordingly, the sealant 320 can also be formed on the color filtering device 200, but not limited by the present invention.

Referring to FIG. 7C, the color filtering device 200 is disposed above the substrate 310, and the color filtering device 200 and the substrate 310 are bonded to each other so that the spacer 250 contacts with the substrate 310 and maintains the cell gap between the substrate 310 and the color filtering device 200. Wherein, the spacers 250 have thicker thickness than conventional ones. Therefore, in the process of bonding the color filtering device 200 to the substrate 310, the spacers 250 are easy to deform laterally by the bonding pressure. It can be know that the spacers 250 are not easily peeled off in the process of composing and aligning the color filtering device 200 and the substrate 310.

Accordingly, those skilled in the art should know that the structures illustrated in FIG. 7A and FIG. 2D are independently formed in practical manufacturing process. Therefore, the order for forming the structures in FIG. 7A and FIG. 2D is not limited in the present invention.

Referring to FIG. 7C, after the substrate 310 and the color filtering device 200 being bonded, a sealant 320 is then solidified to fix the corresponding position of the substrate 310 and the color filtering device 200 so that the composition of the liquid crystal display panel 500 is completed. Wherein, the sealant 320 can be thermal curing sealant or UV curing sealant and the method for solidifying the sealant 320 includes thermal curing and UV curing according to the characteristics of the sealant 320. The following manufacturing process of the liquid crystal display panel 500 is apparent to those skilled in the art, so the description of those is omitted here.

The foresaid embodiment takes the color filtering device 200 of the first embodiment for example illustrating that the liquid crystal display panel composed of the color filtering device of the present invention can have homogeneous cell gaps. Certainly, the liquid crystal display panel composed of the color filtering device 300 in the second embodiment can have the same characteristics. The later paragraph cites an example illustrating the liquid crystal display panel composed of the color filtering device 300 in the second embodiment of the present invention.

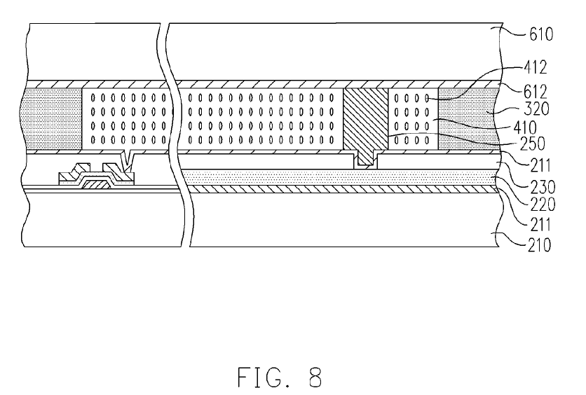

FIG. 8 is a cross-sectional diagram of a liquid crystal display panel to another embodiment of the present invention. The manufacturing processes of the liquid crystal display panel in the present embodiment are similar to the ones of the liquid crystal display panel in the former embodiment so that only two differences are illustrated here. Referring to FIG. 8, the bottom substrate forming the liquid crystal display panel 300 is the color filtering device 300 shown in FIG. 6, and an electrode layer 612 is formed on the top substrate 610. In other words, the liquid crystal display panel 600 is composed of a COA substrate and the top substrate 610.

The present invention inserts the spacers into the color filtering units to increase the area of attachment between the spacers and the electrode layer, so as to enhance the adhesion between the spacers and the color filtering device. Therefore, the lateral shear stress that the spacers can endure is increased to avoid peeling the spacers from the color filter in the following manufacturing process of washing, forming alignment film, or aligning the alignment film. Accordingly, the liquid crystal display panel made according to the present invention has homogeneous cell gap so that the display quality is well maintained.

Furthermore, compared to the conventional spacers directly disposed on the electrode layer above the color filtering units, the spacers in the present invention have thicker thickness. Therefore, in the composing process of the liquid crystal display panel, the spacers can deform laterally to avoid peeling off because of the bonding pressure.

In addition, the color filtering units and the openings therein can be formed in the same manufacturing process in the present invention. Therefore, the present invention will not increase the cost additionally in the manufacturing process of the liquid crystal display panel.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A manufacturing method of liquid crystal display panel, comprising:
providing a first substrate and a second substrate respectively, wherein the first substrate has at least a first electrode layer formed thereon and a patterned light-shielding layer is formed on the second substrate to define a plurality of sub-pixel regions;
forming a color filtering unit in each of the sub-pixel regions on the second substrate and each of the color filtering units is partially overlapped on the patterned light-shielding layer, wherein at least parts of the color filtering units have at least one opening respectively and the openings are disposed above the patterned light-shielding layer;
forming a second electrode layer conformally on the second substrate;
forming a plurality of spacers on the second electrode layer, wherein each of the spacers is inserted into the color filtering units through the corresponding opening; and
composing the first substrate and the second substrate, wherein a liquid crystal layer is formed between the first substrate and the second substrate and the first substrate is disposed corresponding to the second substrate, the cell gaps between the first substrate and the second substrate are maintained by the spacers.

2. The manufacturing method of liquid crystal display panel according to claim 1, wherein the method for forming the spacers comprises:
forming a photoresist material layer on the second electrode layer, wherein the photoresist material layer fills the openings; and
removing the photoresist material layer outside the surroundings of each of the openings to form the spacers.

3. The manufacturing method of liquid crystal display panel according to claim 1, wherein the color filtering units include red color filtering units, green color filtering units, and blue color filtering units.

4. The manufacturing method of liquid crystal display panel according to claim 1, wherein the first substrate is an active device array substrate and the second substrate is a color filter.

5. The manufacturing method of liquid crystal display panel according to claim 1, wherein the second substrate further includes an active device array preformed thereon and the patterned light-shielding layer is formed on the active device array.

6. A manufacturing method of color filtering device, comprising:
providing a substrate with a patterned light-shielding layer formed therein to define a plurality of sub-pixel regions on the substrate;
forming a color filtering unit in each of the sub-pixel regions on the substrate and each of the color filtering units is partially overlapped on the patterned light-shielding layer, wherein at least parts of the color filtering units have at least one opening respectively and the openings are disposed above the patterned light-shielding layer;
forming an electrode layer conformally on the substrate; and
forming a plurality of spacers on the electrode layer, wherein each of the spacers is inserted into one of the color filtering units through the corresponding opening.

7. The manufacturing method of color filtering device according to claim 6, wherein the method for forming the spacers comprises:
forming a photoresist material layer on the electrode layer, wherein the photoresist material layer fills the openings; and
removing the photoresist material layer outside the surroundings of each of the openings to form the spacers.

8. The manufacturing method of color filtering device according to claim 6, wherein the steps of forming the openings in the color filtering units comprise tilting the side walls of the openings corresponding to the bottom surface.

9. The manufacturing method of color filtering device according to claim 6, wherein the color filtering units includes red color filtering units, green color filtering units and blue color filtering units.

10. The manufacturing method of color filtering device according to claim 6, wherein the substrate further includes an active device array formed thereon and the patterned light-shielding layer is formed on the active device array.

11. A liquid crystal display panel, comprising:
a first substrate;
a second substrate, disposed corresponding to the first substrate;
a patterned light-shielding layer, disposed on the surface of the second substrate corresponding to the first substrate to define a plurality of sub-pixel regions on the second substrate;
a plurality of color filtering units, disposed on the sub-pixel regions, respectively, wherein at least a portion of the color filtering units have at least an opening, respectively, and the openings are disposed above the patterned light-shielding layer;
an electrode layer conformally formed, disposed on the patterned light-shielding layer and the color filtering units, and the electrode layer fills the openings;
a plurality of spacers, disposed on the electrode layer and inserted into the color filtering units through the corresponding openings, respectively; and
a liquid crystal layer, disposed between the first substrate and the second substrate.

12. The liquid crystal display panel according to claim 11, further includes an active device array disposed on the first substrate.

13. The liquid crystal display panel according to claim 11, further includes an active device array disposed on the second substrate and the patterned light-shielding layer is disposed on the active device array.

14. The liquid crystal display panel according to claim 11, wherein the color filtering units includes red color filtering units, green color filtering units and blue color filtering units.

15. The liquid crystal display panel according to claim 11, wherein the spacers are pillared spacers.
